(19) United States
(12) Patent Application Publication
(10) Pub. No.: US 2017/0064407 A1
(43) Pub. Date: Mar. 2, 2017

(54) BROADCAST SYSTEM AND METHOD FOR TRANSMITTING ADVERTISEMENTS BASED ON USER PREFERENCE

(71) Applicant: LIVE EVENT TV, LLC, Daytona Beach Shores, FL (US)

(72) Inventors: Leslie BONNER, Daytona Beach Shores, FL (US); Gary BONNER, Daytona Beach Shores, FL (US)

(21) Appl. No.: 15/118,616

(22) PCT Filed: Feb. 13, 2015
(86) PCT No.: PCT/US2015/015773

§ 371 Date: Aug. 12, 2016

Related U.S. Application Data
(60) Provisional application No. 61/939,361, filed on Feb. 13, 2014.

(51) Int. Cl. H04N 21/61; H04H 20/71; H04N 21/414

(52) U.S. Cl. CPC H04N 21/6131; H04N 21/41407; H04H 20/71; H04W 84/12

(57) ABSTRACT

A communication system may include broadcast units, each broadcast unit for broadcasting a video signal, network base stations, a mobile wireless communications device having a network transceiver for communicating with an adjacent network base station, and a broadcast receiver for receiving the video signal, and a server coupled the broadcast units and the adjacent network base station. The server may be for receiving, via the adjacent network base station, a user traffic metric from the mobile wireless communications device, selectively generating the video signal based upon the user traffic metric, and transmitting at least one advertisement to the at least one mobile wireless communications device based upon the at least one user traffic metric.

### TECHNICAL FIELD

The present invention relates to the field of communications, and, more particularly, to video broadcast system and related methods.

### BACKGROUND

A problematic communications application is regularly encountered in sports stadiums and other high density applications. During sporting events, it is not uncommon for many thousands of cellular devices to attempt to connect onto a local cellular tower. Quite expectedly, during these high density applications, the data throughput of the local cellular network deteriorates to the point of non-function.

### SUMMARY

Generally speaking, a communication system may include a plurality of broadcast units, each broadcast unit for broadcasting a video signal, a plurality of network base stations, and at least one mobile wireless communications device comprising a network transceiver for communicating with at least one adjacent network base station from the plurality thereof, and a broadcast receiver for receiving the video signal. The communication system may include a server coupled the plurality of broadcast units and the at least one adjacent network base station. The server may be for receiving, via the at least one adjacent network base station, at least one user traffic metric from the at least one mobile wireless communications device, selectively generating the video signal based upon the at least one user traffic metric, and transmitting at least one advertisement to the at least one mobile wireless communications device based upon the at least one user traffic metric.

In some embodiments, the broadcast receiver may comprise a dongle broadcast receiver. In other embodiments, the broadcast receiver may comprise an integrated broadcast receiver. Each broadcast unit may comprise an ultra high frequency (UHF)/very high frequency (VHF) broadcast unit, and the video signal may comprise a UHF/VHF video signal.

The server may generate the video signal to comprise a plurality of visual elements. For example, the plurality of visual elements may comprise a video portion, a banner advertising portion, and a scrolling ticker portion. The at least one user traffic metric may comprise a plurality thereof including a video source preference.

Additionally, the at least one mobile wireless communication device may be for providing a virtual switch for changing the video source preference, and the server may be for selectively generating the video signal based upon the video source preference.

Each network base station may comprise a cellular network base station, and the network transceiver may comprise a cellular network transceiver. Each network base station may comprise a wireless local area network (WLAN) base station, and the network transceiver may comprise a WLAN network transceiver.

Another aspect is directed to a server in a communication system comprising a plurality of broadcast units, each broadcast unit for broadcasting a video signal, a plurality of network base stations, at least one mobile wireless communications device comprising a network transceiver for communicating with at least one adjacent network base station from the plurality thereof, and a broadcast receiver for receiving the video signal. The server may include a processor and memory cooperating therewith and for receiving, via the at least one adjacent network base station, at least one user traffic metric from the at least one mobile wireless communications device, selectively generating the video signal based upon the at least one user traffic metric, and transmitting at least one advertisement to the at least one mobile wireless communications device based upon the at least one user traffic metric.

Another aspect is directed to a method of operating a communication system comprising a plurality of broadcast units, a plurality of network base stations, at least one mobile wireless communications device comprising a network transceiver for communicating with at least one adjacent network base station from the plurality thereof, and a broadcast receiver for receiving the video signal, and a server coupled the plurality of broadcast units and the at least one adjacent network base station. The method may include operating each broadcast unit to broadcast a video signal, and operating the server to receive, via the at least one adjacent network base station, at least one user traffic metric from the at least one mobile wireless communications device, selectively generate the video signal based upon the at least one user traffic metric, and transmit at least one advertisement to the at least one mobile wireless communications device based upon the at least one user traffic metric.

### BRIEF DESCRIPTION OF THE DRAWINGS

FIG. 1 is a schematic diagram of a communication system, according to the present invention.

FIG. 2 is an interface from an example embodiment of a mobile wireless communications device from the communication system of FIG. 1.

FIG. 3 is a schematic diagram of another example embodiment of the communication system.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

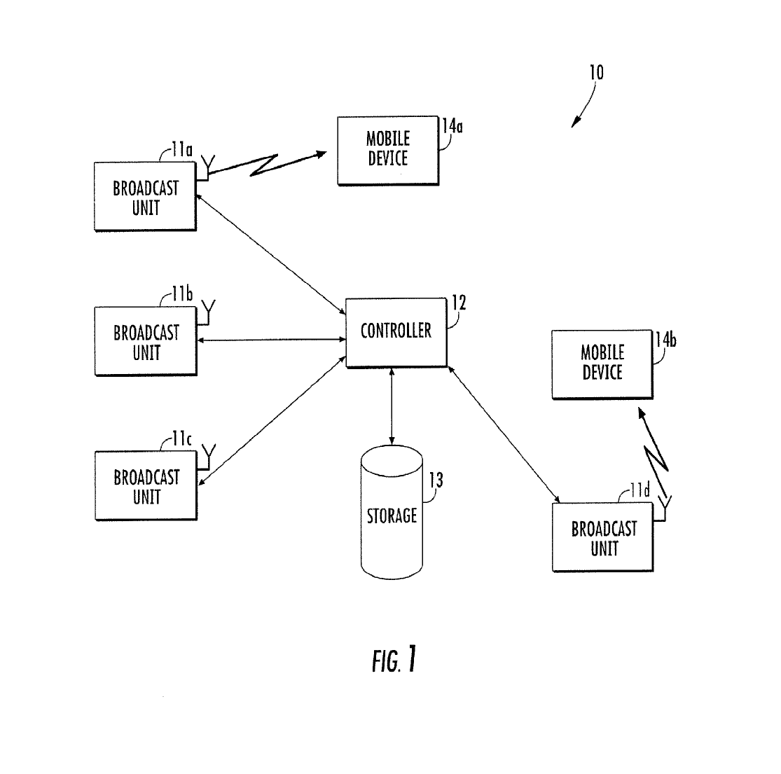

Referring to FIG. 1, a communication system 10 according to the present invention is now described. The communication system 10 may be located within a stadium, or any high density area (i.e. high user density, e.g. concert halls, golf courses, festivals, conferences). The communication system 10 illustratively includes a plurality of broadcast units 11a-11d, and a controller 12 coupled to the broadcast units. Each broadcast unit 11a-11d may comprise a radio frequency (RF) pico-broadcast device comprising an antenna, and an RF transmitter coupled thereto.

Each of the broadcast units 11a-11d broadcasts a signal, for example, an ultra high frequency (UHF)/very high frequency (VHF) signal. Of course, the broadcast units 11a-11d may broadcast on other RF frequencies. The signal may comprise a video signal, and the video signal is tailored to be received within the high density user area, i.e. a closed circuit signal.

The communication system 10 illustratively includes a plurality of mobile wireless communications devices 14a-14b receiving the signal from the broadcast units 11a-11d. Each mobile wireless communications device 14a-14b illustratively includes a broadcast receiver (e.g. UHF, VHF). In particular, the mobile wireless communications devices 14a-14b may comprise cellular devices. For example, the mobile wireless communications devices 14a-14b may comprise a broadcast receiver dongle attached to an accessory port, such as a micro universal serial bus (USB) port or lightening port, for example, or may comprise an integrated broadcast receiver.

The communication system 10 illustratively includes a storage 13 coupled to the controller 12. The controller 12 is coupled to the broadcast units 11a-11d and generates video data for the signal. For example, in stadium deployed embodiments, the video data may comprise instant replay video of the subject event. The video signal may comprise a plurality of elements. The plurality of elements may comprise an actual video portion, a banner advertising portion, and a scrolling ticker portion (e.g. sports scores).

Advantageously, the communication system 10 may readily deliver video to the mobile wireless communications devices 14a-14b regardless of the amount of users in the system. Indeed, for high density applications, the operator may easily change the video stream delivered to users.

In some embodiments, the video signal may comprise a plurality of actual video streams, i.e. a multi-channel video signal. In these embodiments, the mobile wireless communication device 14a-14b may provide a switch for the user to cycle through the actual video streams. In some embodiments, this switch functionality may be provided via a mobile operating system (OS) application (e.g. Apple IOS, Google Android, Windows Mobile, Blackberry OS) on the mobile wireless communications device 14a-14b.

In some embodiments, the controller 12 communicates with the mobile wireless communications devices 14a-14b over the Internet. As is typical in high density applications, the cellular network connection of the mobile wireless communications devices 14a-14b is poor and low bandwidth. Nevertheless, the mobile wireless communications devices 14a-14b can send some device usage statistics (user traffic metrics) to the controller 12. For example, the device usage statistics may comprise data on the video streams being accessed. Using this data, the operator of the stadium can, for example, selectively prioritize the content displayed on the venue large screen video entertainment, i.e. the “jumbotron, or internet broadcast, etc.”

In some embodiments, the controller 12 may provide a payment gateway for the mobile wireless communications devices 14a-14b. For example, the payment gateway may utilize the unstructured supplementary service data (USSD) protocol.

Additionally, the controller 12 may process the user traffic metrics to present special offers to respective mobile wireless communications devices 14a-14b. In these embodiments, the controller 12 would also maintain a user profile database (including cellular telephone number, user ID, password, etc.) in the storage 13. The login process would occur using the aforementioned low bandwidth network connection or available Wi-Fi. Also, the controller could present the special offers to the respective mobile wireless communications device using a text message (short message service) or a push notification.

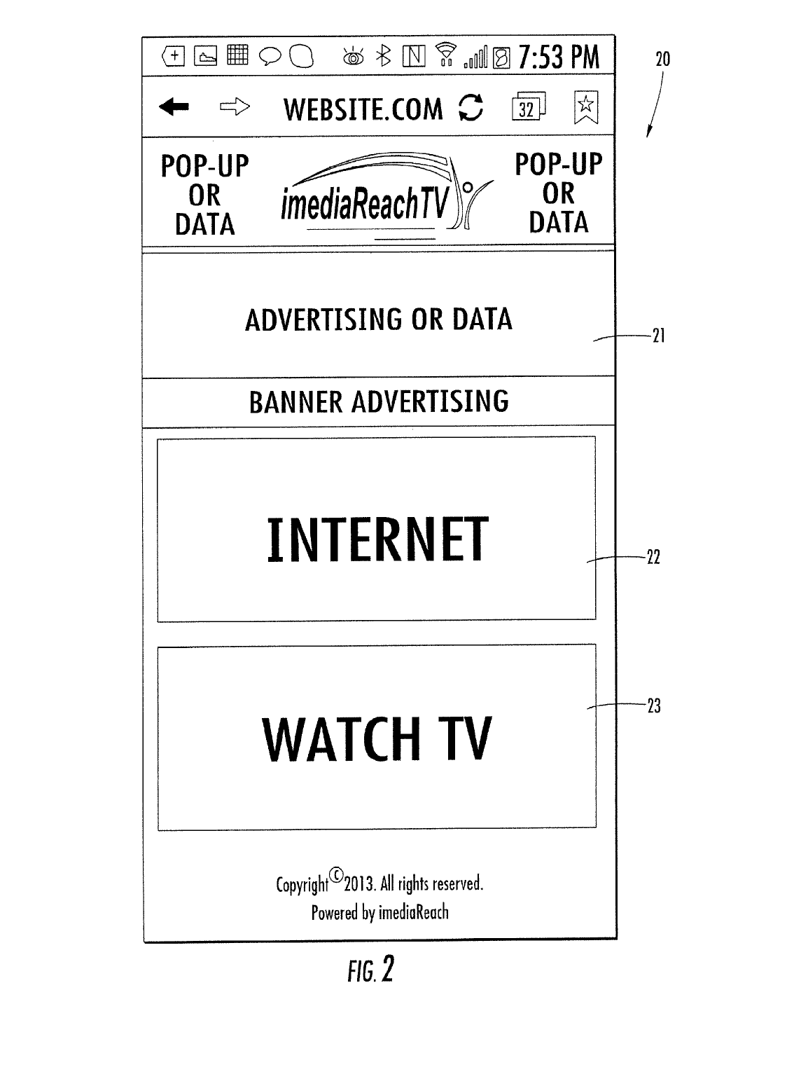

Referring now to FIG. 2, a screenshot of an interface 20 from an example embodiment of the mobile wireless communications device 14a-14b is shown. The interface 20 includes a button 23 to access video streams, and a button 22 for Internet access. The interface 20 illustratively includes an advertising portion 21.

The imediaReach® multi-access App, imediaReachTV, is a web based App for all operating systems and a native mobile operating system App provided via a mobile OS application (e.g. Apple IOS, Google Android, Windows Mobile, Blackberry OS) operating systems, which manages the user experience for smart phone or tablet (appliance), whereby the user can receive streaming audio & video via a UHF/VHF antenna equipped appliance, without the need for cellular or Wi-Fi network coverage and can navigate seamlessly between channels of video, or where available, the Internet via Cellular or Wi-Fi.

The App will encompass the following:

1) User Interface for UHF TV transmission reception rendering video and audio onto the end user's wireless device
2) Multi-button visual user interface for end user (TV and Internet, TV channels, Answer a call pop-up, Respond to a text message pop-up, etc.)
3) Ability to process payments; i.e. a payment gateway
4) On board metrics captured on user behavior, with batch export to metrics database/dyeayashboard
5) Location based metrics and ability to map venue locations based on location of end user, via Mac ID, global positioning system (GPS), & Cell ID
6) Front end registration page with terms and conditions to capture end user registration information metrics for download
7) Premium content option for certain TV channels on downloads
8) Continuous audio option of event audio broadcast
9) Multi□channel selection option for end user—change channels
10) Digital advertising banner ad space
11) Push App notification ability
12) Mac-ID capture, reporting, and subsequent recognition/tracking
13) Auto detection reporting of Mac address
14) Controlled routing of browsing to target URLs
15) Geo-mapping feature to note location of user in proximity of TV & Wi-Fi network hot spots
16) Frame within frame option for delivery of another video channel, stats, advertising, etc.
17) Caller ID window pop-up for inbound calls
18) Ability to capture snapshot of video screen and save option (Snap & Save)
19) Continuous recording and replay of video segment (like TVO)
20) Split screen option for video/video, or video/internet browse viewing

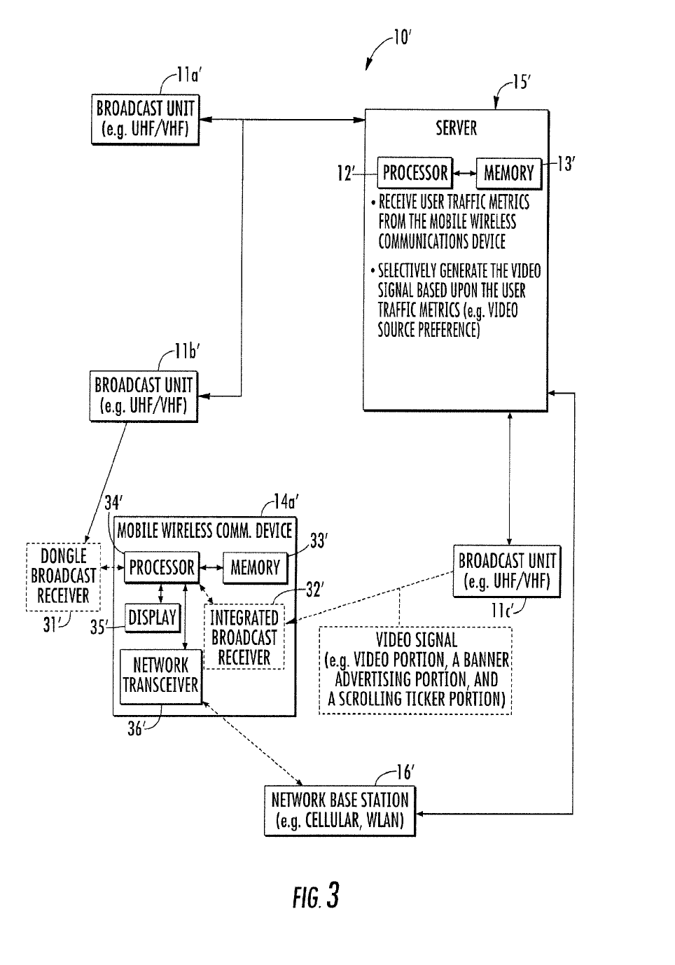

Referring now additionally to FIG. 3, another embodiment of the communication system 10′ is now described. In this embodiment of the communication system 10′, those elements already discussed above with respect to FIGS. 1-2 are given prime notation and most require no further discussion herein. This embodiment differs from the previous embodiment in that this communication system 10′ has the mobile wireless communications device 14a′ comprising a processor 34′, a memory 33′ coupled to the processor, a display 35′ coupled to the processor and providing the interface 20 (FIG. 2), and a network transceiver (e.g. cellular or WLAN) 36′ coupled to the processor and communicating with at least one adjacent network base station 16′. The mobile wireless communications device 14a′ also includes one or more of the dongle-style broadcast receiver 31′ or an integrated broadcast receiver 32′ (both shown with dashed lines) receiving the video signal from the broadcast units 11a′-11c′. Also, this communication system 10′ provides the controller and storage of the embodiment of FIG. 1 within a server 15′.

In one embodiment, some or all of the mobile wireless communications devices 14a-14b comprise a geolocation unit, such as a GPS receiver. The mobile wireless communications device 14a-14b determines a geolocation position from the geolocation unit, and includes the geolocation position in the device usage statistics. The server 15′ may then specifically generate the video signal independently for geographic regions in large area deployments, such as golf course live event applications.

For example, in the golf course live event application, the video signal for a geographic region (i.e. golf course hole) should not include views from holes in the same geographic region, since the user is already physically present. Also, the server 15′ could tailor commercial offers/advertisements in the video signal for specific geographic regions (e.g. advertisements for a vendor are only included in the video signal broadcast in the same geographic region). Of course, in these embodiments, the server 15′ is aware of the current geographic (likely fixed) placement of the broadcast units 11a-11c so that the proper video signal is broadcast in each geographic region.

Also, in some embodiments, the server 15′ stores user viewing behavioral data in the user profile database. Using the user profile database, the server 15′ may present future offers to the user using the contact information in the respective user profile. In particular, since the server 15′ requires contact information to setup a user account, the server 15′ can be configured to contact the user long after the live event has ended.

In embodiments where the server 15′ transmits at least one advertisement to the at least one mobile wireless communications device based upon the at least one user traffic metric, the transmission may be via the video signal, or sent via the at least one adjacent network base station 16′. In other embodiments, the at least one advertisement may be sent via one or more of SMS messaging, e-mail messaging, or a push notification. Also, the transmission of the at least one advertisement may occur during the live event or subsequently.

Of course, the server 15′ may capture a media access control address (MAC address) or cell phone number of mobile devices 14a-14b, 14a′ once the associated user registers an account. This may facilitate future transmission of the at least one advertisement. Also, to address regulatory concerns, during the registration, the server 156′ would present and secure prior written consent to re-market the user's cell phone number.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A communication system comprising:
a plurality of broadcast units, each broadcast unit for broadcasting a video signal;
a plurality of network base stations;
at least one mobile wireless communications device comprising a network transceiver for communicating with at least one adjacent network base station from said plurality thereof, and a broadcast receiver for receiving the video signal; and
a server coupled said plurality of broadcast units and the at least one adjacent network base station, said server for
receiving, via the at least one adjacent network base station, at least one user traffic metric from said at least one mobile wireless communications device, the at least one user traffic metric comprising a video source preference,
selectively generating the video signal for broadcast and based upon the video source preference, and
transmitting at least one advertisement to said at least one mobile wireless communications device based upon the at least one user traffic metric.

2. The communication system of claim 1 wherein said broadcast receiver comprises a dangle broadcast receiver.

3. The communication system of claim 1 wherein said broadcast receiver comprises an integrated broadcast receiver.

4. The communication system of claim 1 wherein each broadcast unit comprises an ultra high frequency (UHF)/very high frequency (VHF) broadcast unit; and wherein the video signal comprises a UHF/VHF video signal.

5. The communication system of claim 1 wherein said server generates the video signal to comprise a plurality of visual elements, said plurality of visual elements comprising a video portion, a banner advertising portion, and a scrolling ticker portion.

6. The communication system of claim 1 wherein the at least one user traffic metric comprises a plurality thereof including the video source preference.

7. The communication system of claim 6 wherein said at least one mobile wireless communication device is for providing a virtual switch for changing the video source preference; and wherein said server is for selectively generating the video signal based upon the video source preference.

8. The communication system of claim 1 wherein each network base station comprises a cellular network base station; and wherein said network transceiver comprises a cellular network transceiver.

9. The communication system of claim 1 wherein each network base station comprises a wireless local area network (WLAN) base station; and wherein said network transceiver comprises a WLAN network transceiver.

10. A communication system comprising:
a plurality of ultra high frequency (UHF)/very high frequency (VHF) broadcast units, each broadcast unit for broadcasting a UHF/VHF video signal;
a plurality of cellular network base stations;
at least one mobile wireless communications device comprising a cellular network transceiver for communicating with at least one adjacent cellular network base station from said plurality thereof, and a UHF/VHF broadcast receiver for receiving the UHF/VHF video signal; and
a server coupled said plurality of UHF/VHF broadcast units and the at least one adjacent cellular network base station, said server for
receiving, via the at least one adjacent cellular network base station, at least one user traffic metric from said at least one mobile wireless communications device, the at least one user traffic metric comprising a video source preference,
selectively generating the UHF/VHF video signal for broadcast and based upon the video source preference, the UHF/VHF video signal comprising a plurality of visual elements, said plurality of visual elements comprising a video portion, a banner advertising portion, and a scrolling ticker portion, and
transmitting at least one advertisement to said at least one mobile wireless communications device based upon the at least one user traffic metric.

11. The communication system of claim 10 wherein said UHF/VHF broadcast receiver comprises a dongle UHF/VHF broadcast receiver.

12. The communication system of claim 10 wherein said UHF/VHF broadcast receiver comprises an integrated UHF/VHF broadcast receiver.

13. The communication system of claim 10 wherein the at least one user traffic metric comprises a plurality thereof including a video source preference.

14. The communication system of claim 13 wherein said at least one mobile wireless communication device is for providing a virtual switch for changing the video source preference; and wherein said server is for selectively generating the UHF/VHF video signal based upon the video source preference.

15. A server in a communication system comprising a plurality of broadcast units, each broadcast unit for broadcasting a video signal, a plurality of network base stations, at least one mobile wireless communications device comprising a network transceiver for communicating with at least one adjacent network base station from the plurality thereof, and a broadcast receiver for receiving the video signal, the server comprising:
a processor and memory cooperating therewith and for
receiving, via the at least one adjacent network base station, at least one user traffic metric from the at least one mobile wireless communications device, the at least one user traffic metric comprising a video source preference,
selectively generating the video signal for broadcast and based upon the video source preference, and
transmitting at least one advertisement to said at least one mobile wireless communications device based upon the at least one user traffic metric.

16. The server of claim 15 wherein each broadcast unit comprises an ultra high frequency (UHF)/very high frequency (VHF) broadcast unit; and wherein the video signal comprises a UHF/VHF video signal.

17. The server of claim 15 wherein said processor and memory are for generating the video signal to comprise a plurality of visual elements, said plurality of visual elements comprising a video portion, a banner advertising portion, and a scrolling ticker portion.

18. The server of claim 15 wherein the at least one user traffic metric comprises a plurality thereof including a video source preference.

19. A mobile wireless communications device in a communication system comprising a plurality of broadcast units, each broadcast unit for broadcasting a video signal, a plurality of network base stations, and a server coupled said plurality of broadcast units and at least one adjacent network base station, said server for selectively generating the video signal for broadcast and based upon at least one user traffic metric, the mobile wireless communications device comprising:
a network transceiver for communicating with at least one adjacent network base station from the plurality thereof;
a broadcast receiver for receiving the video signal; and
processor and memory cooperating with said network transceiver and said broadcast receiver for
transmitting, via the at least one adjacent network base station, the at least one user traffic metric to the server, the at least one user traffic metric comprising a video source preference, and
receiving at least one advertisement from the server based upon the at least one user traffic metric.

20. The mobile wireless communications device of claim 19 wherein said broadcast receiver comprises a dongle broadcast receiver.

21. The mobile wireless communications device of claim 19 wherein said broadcast receiver comprises an integrated broadcast receiver.

22. The mobile wireless communications device of claim 19 wherein the at least one user traffic metric comprises a plurality thereof including a video source preference.

23. A method of operating a communication system comprising a plurality of broadcast units, a plurality of network base stations, at least one mobile wireless communications device comprising a network transceiver for communicating with at least one adjacent network base station from the plurality thereof, and a broadcast receiver for receiving the video signal, and a server coupled the plurality of broadcast units and the at least one adjacent network base station, the method comprising:
operating each broadcast unit to broadcast a video signal;
operating the server to
receive, via the at least one adjacent network base station, at least one user traffic metric from the at least one mobile wireless communications device, the at least one user traffic metric comprising a video source preference,
selectively generate the video signal for broadcast and based upon the video source preference, and
transmit at least one advertisement to the at least one mobile wireless communications device based upon the at least one user traffic metric.

24. The method of claim 23 wherein the broadcast receiver comprises a dangle broadcast receiver.

25. The method of claim 23 wherein the broadcast receiver comprises an integrated broadcast receiver.

26. The method of claim 23 wherein each broadcast unit comprises an ultra high frequency (UHF)/very high frequency (VHF) broadcast unit; and wherein the video signal comprises a UHF/VHF video signal.

27. The method of claim 23 further comprising operating the server to generate the video signal to comprise a plurality of visual elements, the plurality of visual elements comprising a video portion, a banner advertising portion, and a scrolling ticker portion.

28. The method of claim 23 wherein the at least one user traffic metric comprises a plurality thereof including a video source preference.
